(19) United States
(12) Patent Application Publication
(10) Pub. No.: US 2010/0073735 A1
(43) Pub. Date: Mar. 25, 2010

(54) CAMERA-BASED DOCUMENT IMAGING

(75) Inventors: Martin G. Hunt, Mountain View, CA (US); Maria A. Pavlovskaia, San Francisco, CA (US); Logan M.K. Gordon, Del Mar, CA (US); William W. Tipton, Washington, DC (US); Trang T. Pham, Haltom City, TX (US); Darryl H. Yong, Pasadena, CA (US); Weiqing Gu, Claremont, CA (US); James O. Egan, Los Angeles, CA (US); Liangnan Wu, Foster City, CA (US); Kin-Chung Wong, Long Beach, CA (US)

Correspondence Address: DICKSTEIN SHAPIRO LLP, 1825 EYE STREET NW, Washington, DC, 20006-5403, US

(73) Assignee: COMPULINK MANAGEMENT CENTER, INC.

(21) Appl. No.: 12/436,775

(22) Filed: May 6, 2009

Related U.S. Application Data
(60) Provisional application No. 61/126,781, filed on May 6, 2008.
(60) Provisional application No. 61/126,779, filed on May 6, 2008.

(51) Int. Cl. H04N 1/40

(52) U.S. Cl. 358/462

(57) ABSTRACT

A process and system to transform a digital photograph of a text document into a scan-quality image is disclosed. By extracting the document text from the image, and analyzing visual clues from the text, a grid is constructed over the image representing the distortions in the image. Transforming the image to straighten this grid removes distortions introduced by the camera image-capture process. Variations in lighting, the extraction of text line information, and the modeling of curved lines in the image may be corrected.

### CROSS-REFERENCE TO RELATED APPLICATIONS

The present application claims priority under 35 U.S.C. 119(e) to U.S. Provisional Application No. 61/126,781 filed May 6, 2008 and U.S. Provisional Application No. 61/126,779 filed May 6, 2008, both of which are hereby incorporated by reference.

### BACKGROUND

1. Technical Field

This application generally relates to digital image processing and, more particularly, to processing an image taken by a camera.

2. Description of Related Art

Document management systems are becoming increasingly popular. Such systems ease the burden of storing and handling large databases of documents. Many organizations store large amounts of information in physical documents that they wish to convert to a digital format for ease of management. Currently, a combination of optical scanning and optical character recognition (OCR) technology, such as that embodied in ABBYY-FineReader Pro 8.0, converts these documents into an electronic form. However, this process can be inconvenient, especially for forms of media such as bound volumes or posters, which are difficult to scan quickly and accurately. Additionally, the process of preparing documents and then scanning them can be slow.

It is preferable to store images that are aesthetically pleasing and contain only minor distortions. When images contain serious distortions, they can be harder to read since the distortions are distracting. Moreover, optical character recognition assumes the input image contains no distortions. For the purpose of this application, document images without significant distortions are referred to herein as “ideal images.”

In many situations, modern digital cameras have the potential to improve the digitizing process. Cameras are generally smaller and easier to operate than scanners. Also, documents do not require much preparation before being captured by cameras. For example, posters or signs can remain on walls. The drawback to this flexibility is the introduction of imperfections into the image. Photographs captured by cameras may be distorted in ways that scanned images are not. The most noticeable effects are distortions caused by perspective, the camera lens, uneven lighting conditions, and physically warped documents. Current OCR technology expects its input from scanners, and thus does not perform the necessary preprocessing to handle the aforementioned distortions in captured images of documents. OCR technology is a crucial component of processing images in document management software, and thus the distortions introduced by cameras when capturing an image of a document currently makes cameras an unsatisfactory alternative to scanners. Dewarping camera-captured document images and removing distortions, therefore, is a necessary process to the transition from scanners to cameras.

The majority of research concerning image correction focuses on specific types of warping. One approach to flattening an arbitrarily warped document, projects the photograph onto a 3D grid approximating the original document surface. (See Michael S. Brown and W. Brent Seales, Image restoration of arbitrarily warped documents, IEEE Transactions on Pattern Analysis and Machine Intelligence, 26(10):1295-1306, 2004.) The flattening algorithm models the grid as a collection of point-masses connected by springs and influenced by gravity. By letting the springs settle into a state of minimum potential energy, the algorithm attempts to minimize stretching of the surface. While this approach has proven success, it relies on time-step physical modeling. The experimental runtime of this algorithm is on the order of minutes, which is too slow. Additionally, the algorithm assumes it has an accurate 3D surface representing the document, which would have to be reconstructed from information extracted from a 2D image.

One method to dewarp an image without prior knowledge of the document surface is to build a grid over the image based on information gathered from text lines inside the document. (See Shijian Lu and Chew Lim Tan, Document flattening through grid modeling and regularization, Proceedings of the 18th International Conference on Pattern Recognition, 01:971-974, 2006.) This method assumes that text lines are straight and evenly spaced in the original document and that curvature within each grid cell is approximately constant. Every grid cell represents an equal sized square in the original document. In the warped image, the top and bottom sides of the grid cell should be parallel to the tangent vectors and the left and right sides of the grid cell should be parallel to the normal vectors. Each quadrilateral cell is mapped into a square using a linear transformation, effectively dewarping the document. In some situations, this approach lacks the information needed to determine alignment and spacing of vertical cell boundaries. Some have attempted to obtain this information using “vertical stroke analysis,” which focuses on straight line segments of individual characters as indicia of the vertical direction of the text. (See Shijian Lu Chen, Ben M. Chen, and C. C. Ko, Perspective rectification of document images using fuzzy set and morphological operations, Image and Vision Computing, 24:541-553, 2005.)

Another approach models pages as developable surfaces in order to create a continuous, smooth transformation without an intermediate grid structure. (See Jian Liang, Daniel DeMenthon, and David Doermann, Unwarping Images of Curved Documents Using Global Shape Optimization, In Proc. First International Workshop on Camera-based Document Analysis and Recognition, pages 25-29, 2005.) A developable surface is the result of warping a flat plane without stretching. This approach attempts to find the rulings of the surface by analyzing the text. Rulings are the lines along the surface that were straight before the plane was warped. The inverse transformation dewarps the surface by rectifying the rulings.

None of these approaches, however, have been found completely satisfactory to dewarp documents captured using digital cameras.

### SUMMARY

It is an object of the present invention to address or at least ameliorate one or more of the problems associated with digital image processing noted above. Accordingly, a method for processing a photographed image of a document containing text lines comprising text characters having vertical strokes is provided. The method comprises analyzing the location and shape of the text lines and straightening them to a regular grid to dewarp the image of the document image. In one embodiment, the method comprises three major steps: (1) text detection, (2) shape and orientation detection, and (3) image transformation.

The text detection step finds pixels in the image that correspond to text and creates a binary image containing only those pixels. This process accounts for unpredictable lighting conditions by identifying the local background light intensities. The text pixels are grouped into character regions, and the characters are grouped into text lines.

The shape and orientation detection step identifies typographical features and determines the orientation of the text. The extracted features are points in the text that correspond to the tops and bottoms of text characters (tip points) and the angles of the vertical lines in the text (vertical strokes). Also, curves are fit to the top and bottom of text lines to approximate the original document shape.

The image transformation step relies on a grid building process where the extracted features are used as a basis to identify the warping of the document. A vector field is generated to represent the horizontal and vertical stretch of the document at each point. Alternatively, an optimization-problem based approach can be used.

Further aspects, objects, and desirable features, and advantages of the invention will be better understood from the following description considered in connection with the accompanying drawings in which various embodiments of the disclosed invention are illustrated by way of example. It is to be expressly understood, however, that the drawings are for the purpose of illustration only and are not intended as a definition of the limits of the invention.

### BRIEF DESCRIPTION OF THE DRAWINGS

FIG. 1 is a flow diagram illustrating steps of a camera-based document image dewarping process.

FIG. 2 illustrates a photograph comprising an exemplary image of a document containing text lines.

FIG. 3 illustrates an output image of the photograph of FIG. 2 after binarization using a naïve thresholding on the image of FIG. 2.

FIG. 4 illustrates an output image of the photograph of FIG. 2 after binarization using Retinex-type normalization and then thresholding.

FIG. 5 illustrates a grayscale image of a document containing text lines that is extremely warped together with other documents in view that was created from a photograph of the document.

FIG. 6 illustrates an output image after a filtering process was performed on the image of FIG. 5.

FIG. 7 illustrates an output image after a rough thresholding process was carried out on the output image of FIG. 6.

FIG. 8 illustrates an output image after a process has been carried out on the output image of FIG. 6 in which the foreground (areas initially identified as text) has been removed and blank pixels have been interpolated.

FIG. 9 illustrates an output image after a complete binarization process has been performed on the image of FIG. 5.

FIG. 10 is a diagram illustrating various features in English typography.

FIG. 11 illustrates a photographic image of a document with text lines in which control points have been marked in dark and light dots.

FIG. 12 illustrates an output image after an optimization-based dewarping process was performed on the image of FIG. 11.

FIG. 13 depicts one embodiment of a system for processing a captured image.

FIG. 14 is a flow diagram illustrating steps of an alternative embodiment of a camera-based document image dewarping process.

FIG. 15 is a flow diagram illustrating yet another embodiment of the steps of a camera-based document image dewarping process.

### DETAILED DESCRIPTION

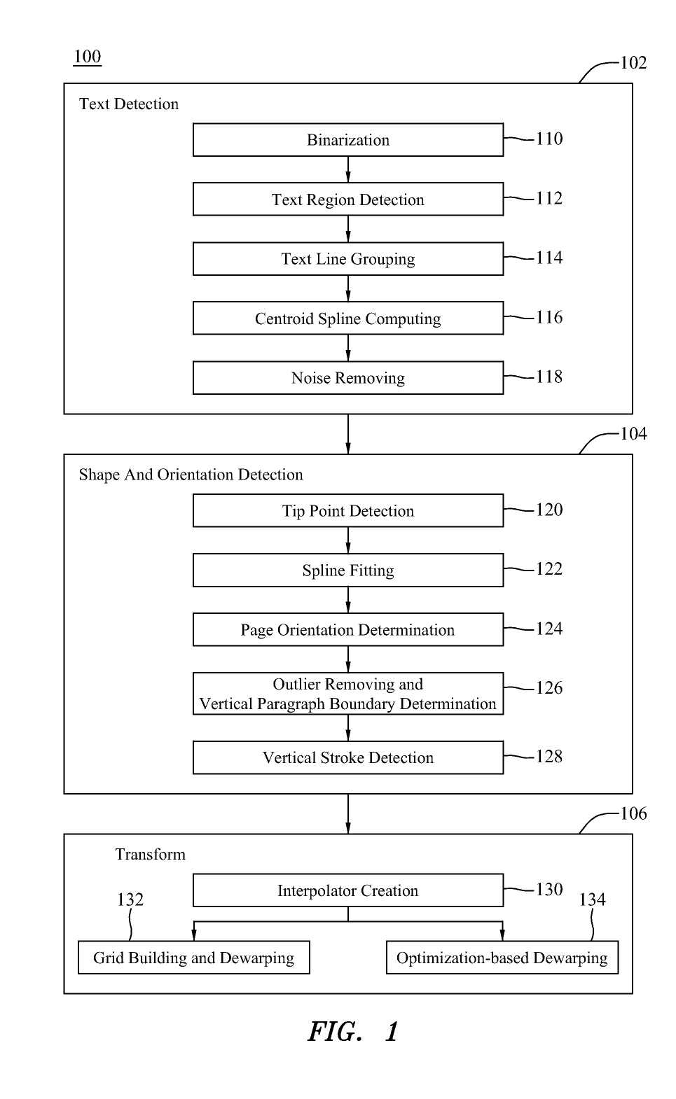

Embodiments of the invention will now be described with reference to the drawings. To facilitate the description, any reference numeral representing an element in one figure will represent the same element in any other figure. FIG. 1 is a flow diagram illustrating steps of a camera-based document image dewarping process according to one embodiment of the present invention.

Referring to FIG. 1, a method 100 for dewarping a document image captured by a camera is provided. The method 100 involves analyzing the location and shape of the text lines included in the imaged document and then straightening them to a regular grid. In the illustrated embodiment, method 100 comprises three major steps: (1) a text detection step 102, (2) a shape and orientation detection step 104, and (3) an image transformation step 106. Each of the major steps may further comprise several sub-steps as described below.

1. Text Detection

The text detection step 102 finds pixels in the image that correspond to text and creates a binary image containing only those pixels. In the present embodiment, the text detection step 102 accounts for unpredictable lighting conditions by identifying the local background light intensities. To suitably identify text in the present embodiment, five sub-steps are performed in the text detection step 102. These sub-steps are binarization step 110, text region detection step 112, text line grouping step 114, centroid spline computing step 116, and noise removing step 118. In other embodiments, different sub-steps may be used, or their order may be altered.

1.1. Binarization

Binarization 110 is the process of identifying pixels in an image that make up the text so as to partition the image into text and non-text pixels. The goal of binarization is to locate text and eliminate extraneous information by extracting useful information about the shape of the document from the image. This process takes the original color image as input. The output is a binary matrix of the same dimensions as the original image with zeros marking the location of text in the input image and ones everywhere else. In other implementations, this could be reversed. The binarization process preferably involves (a) pixel normalization, (b) thresholding, and (c) artifact removal, which are each described in more detail below.

a. Pixel Normalization

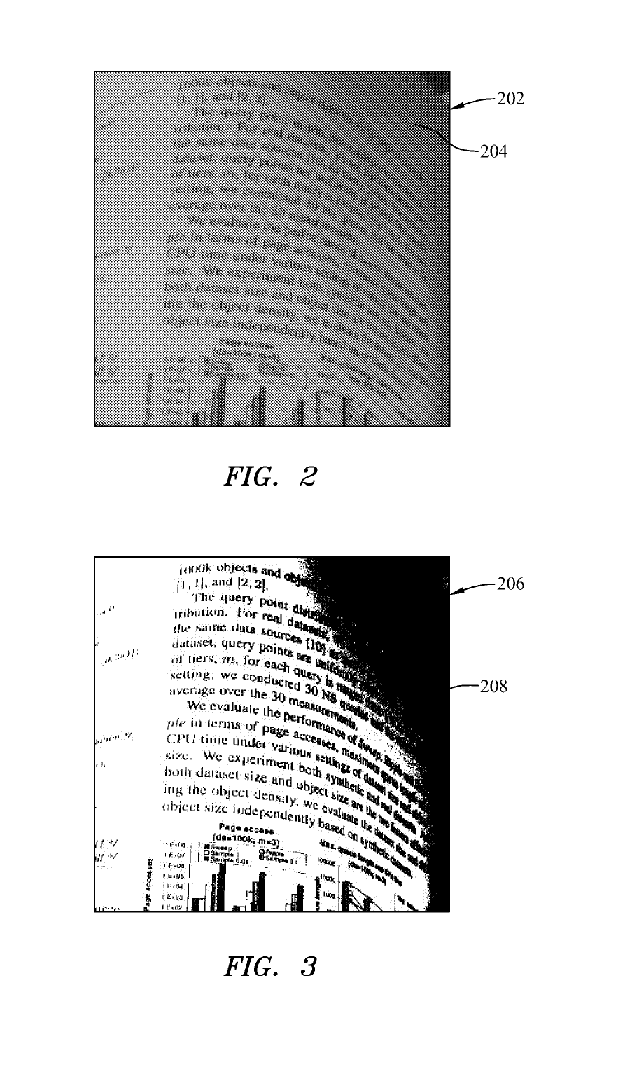

Typically, text pixels are darker than their surroundings. A naïve, or rough, binarization technique typically employs a particular threshold value and assumes that, on an image, all pixels lighter than the threshold value are white while all pixels darker than the threshold value are black. While such techniques work well for scanned documents, a single global threshold value will not work well for various images captured by photographing documents due to differences in lighting and font weight. FIG. 2 illustrates a photograph comprising an exemplary image 202 of a document containing text lines and having poor imaging quality. Notice that on the top-right area 204 of the image 202, the lighting is darker compared to the rest of the image 202 due to warping of the original document. FIG. 3 illustrates an output image 206 of the photograph of FIG. 2 after binarization using a naïve thresholding on the image 202 of FIG. 2. Notice that the whole top-right area 208 of the image 202 is considered as text area.

To account for such intensity variation, in one embodiment, a normalization operation may be performed on each pixel based on the relative intensity compared to that of its surroundings. In this respect, the method from Retinex may be employed. (See Glenn Woodell, Retinex image processing, http://dragon.larc.nasa.gov/, 2007.) According to Retinex, the original image is divided into blocks that are large enough to contain several text characters, but small enough to have more consistent lighting than the page as a whole. Because there are generally less text pixels than background pixels in a normal document, the median value in a block will be approximately the intensity value of the background paper in the particular block. Then each pixel value can be divided by the block's median value to obtain a normalized value.

It should be understood that the size of a block may be adjusted and a plurality of block sizes may be employed. If, for example, the size of a block is too large, then a median value of the block may not accurately represent the background due to uneven lighting over the page. On the other hand, if the block size is too small compared to the size of a text character, then the median value could be erroneously representing the text intensity instead of the background intensity. Furthermore, a single block size may not be appropriate for a whole image due to the changing conditions over the page of a document. For example, text characters in headers are often larger and thus a larger block size is required.

One procedure for determining an appropriate block size that may be employed is done by taking the whole image and dividing it into many very small blocks. The blocks are then recombined gradually. At each level of recombination, there is an assessment of whether or not the current block is large enough to be used. The recombination process can be stopped at different points on the page. Whether the block size is “big enough” may be based on an additional heuristic. For example, the application of the discrete second derivative, or Laplacian operator, to the input image can be applied because a nonzero Laplacian is very highly correlated with the location of text in a document. Accordingly, sizing a block to contain a certain amount of summed Laplacian value may ensure that the block is big-enough to contain several text characters.

It should be understood that the above-described methods for determining whether a block is big enough for purposes of normalization may be fine tuned to a particular application (e.g., camera type, document type, lighting, etc.).

b. Thresholding

When pixels are normalized against the background paper color as described previously, pixels on the background would have normalized values around one while pixels on text have much lower normalized values. Therefore, such a comparison would not be affected by the absolute lightness or darkness of the image. It is also independent of local variation in lighting across the page since the normalized operation on a pixel can be performed by using its local environment only.

To differentiate between white and black color values, a threshold value is selected. However, since the intensity characteristics of individual images have been filtered out via normalization as described above, a single threshold value is capable of working consistently for most images. Further, because the normalized background has pixel values of around one, in one embodiment, a threshold of slightly below one, e.g., 0.90 or 0.95, is selected. In other embodiments, it is contemplated that other suitable threshold values may also be employed and that different blocks may employ different values.

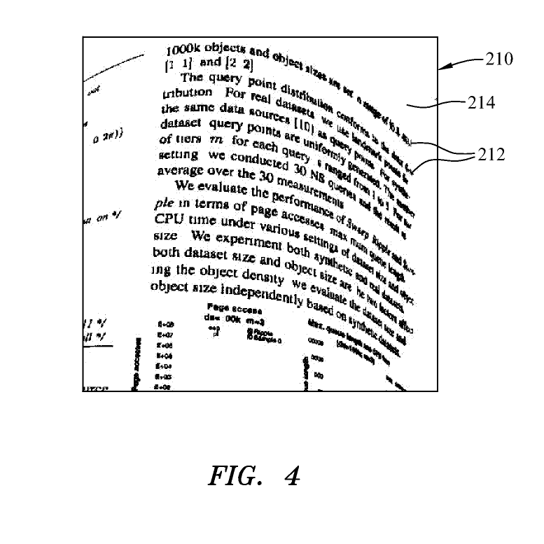

FIG. 4 illustrates an output image resulting when binarization with localized normalization followed by thresholding according to the present invention is performed on the non-ideal image illustrated in FIG. 2. Noticeable improvements are observed when compared to the results of the naïve binarization illustrated in FIG. 3. In FIG. 4, the text lines 212 in the top-right area are now distinguishable from the background 214.

c. Artifact Removal

In many cases there will be artifacts, or noise, in the thresholded image as shown in FIG. 4. The goal at this stage is to identify and remove false positives, or noise. For example, the edges of a paper tend to be thin and dark relative to their surroundings. There may also be noise in the background when a particular block contains no text. Such noises, including, for example, noise resulting from lighting aberrations, could be identified as text. As a result, an additional post-processing is preferably used to remove noise.

One process for removing noise separates black, or text, pixels from the binarized image into connected components. Three criteria are used to discard connected regions that are not text. The first two criteria are used to check whether the region is “too big” or “too small” based on the number of pixels. The third criterion is based on the observation that if a region consists entirely of pixels that were close to the first threshold, the region is probably noise. A real text character, or character, may have some borderline pixels but the majority of it should be much darker. Thus, the average normalized value of the whole region can be checked and regions whose average normalized value is too high should be removed. These criteria introduce three new parameters: the minimum region area, the maximum region area, and a threshold for region-wise average pixel values. The region-wise threshold should be lower (more strict) than the pixel-wise threshold to have the desired effect on removing noise.

In the above described pixel normalization step of the binarization process, an estimate of the background paper color is made, then pixels are identified as text if they are significantly darker than that color, and the image broken into blocks, assuming that the median color in each block as its background paper color. The method works well provided that the parameters previously mentioned are well chosen. However, what constitutes well chosen parameters sometimes varies drastically from image to image or even from one part of an image to another. To avoid these problems, the alternative binarization process described below may be employed.

Alternatively, in the present embodiment, the binarization step 110 may be done by performing the following preferable steps. First, a rough estimate of the foreground is made by a rough thresholding method. Parameters for this rough thresholding are selected so that we err on the side of identifying too many pixels as text. Then, these foreground pixels are removed from the original image based on the selected threshold. Then, the holes left by the removal of foreground pixels are filled by interpolating from the remaining values. This provides a new estimate for the background by removing the initial thresholding and interpolating over the holes. Finally, thresholding can now be done based on an improved estimate of the background. This process works well even when the uneven lighting conditions are presented on a photographed documents. A more detailed description of how to carry out this preferred binarization step 110 is provided below.

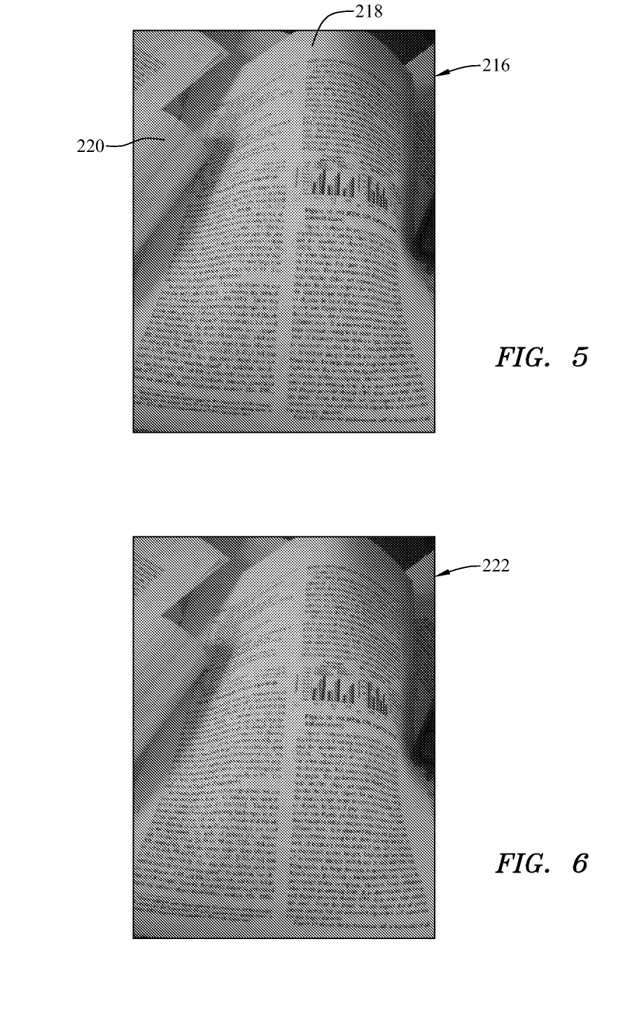

First, a photograph of a document comprising text lines is converted to a gray scale image 216 as shown in FIG. 5. Gray scale image 216 comprises an exemplary image of a document containing text lines in which a main document 218, which is extremely warped, is shown together with other documents 220 in view. In one embodiment, the conversion to grayscale can be implemented by using Matlab's rgb2gray function.

Second, the image is preprocessed to reduce noise, thereby smoothing the captured image. In one embodiment, the smoothing may be done by using a Wiener filter which is a low-pass filter. The image 222 shown in FIG. 6 illustrates an output image after a filtering process was performed on the image of FIG. 5. Although the image 222 shown in FIG. 6 looks similar to its input image 216 shown in FIG. 5, the filter is good for removing salt-and-pepper type noise. The Wiener filter can be performed, for example, by using Matlab's wiener2 function with a 3×3 neighborhood.

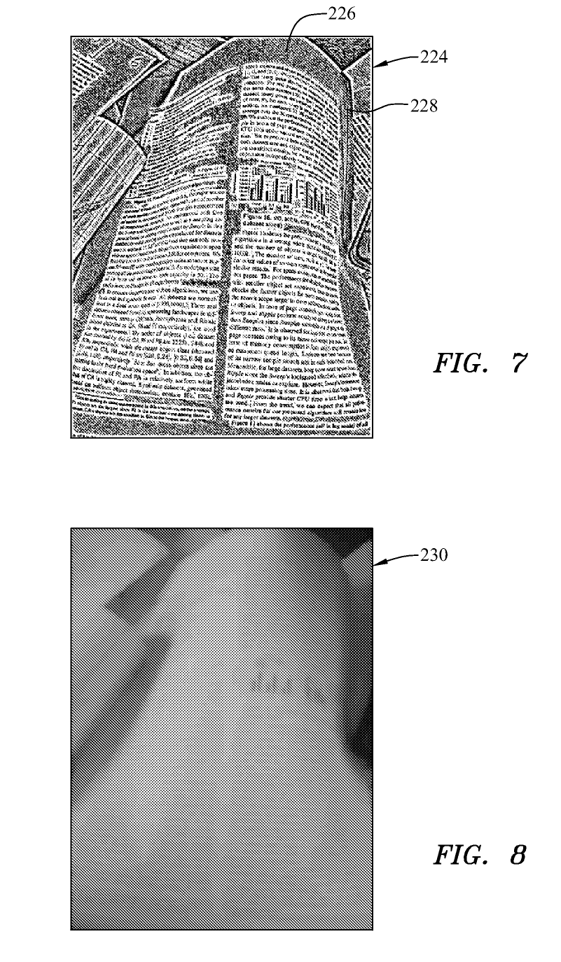

Third, the foreground is estimated by using a naïve, or rough, thresholding. In the present embodiment, the method is due to Sauvola, which calculates the mean and standard deviation of pixel values in a neighborhood about each pixel and uses that data to decide whether each pixel is dark enough to likely be a text. (See J. Sauvola and M. Pietikainen, Adaptive Document Image Binarization, Pattern Recognition, Vol. 33, pp. 225-236, 2000, which is hereby incorporated by reference.) FIG. 7 illustrates an output image 224 after the rough thresholding process was carried out on the output image 222 of FIG. 6. In other embodiments, methods such as Niblack's can also be used. (See Wayne Niblack, An Introduction to Digital Image Processing, Section 5.1, pp. 113-117, Prentice Hall International, 1985, which is hereby incorporated by reference.)

In areas like the top of the page 226 where the standard deviation is very small, the output is mostly noise. This is one of the reasons the window size is important. Noise also appears when the contrast is sharp such as around the edges 228 of the paper. However, the presence of noises artifacts is inconsequential because noise artifacts can be removed in a later stage. In the present embodiment, a large number of false positives, rather than false negatives, are chosen because the following steps work best if there are no false negatives.

Forth, the background can be found by first removing the foreground (areas initially identified as text) via initial thresholding and then interpolating over the holes due to the removal of the foreground. For those pixels that were identified as text via the initial thresholding, their color values are replaced by interpolating the color values of neighboring pixels to approximate the background as shown in the image 230 in FIG. 8. FIG. 8 illustrates an output image 230 after a process has been carried out on the output image 224 of FIG. 7 in which the foreground has been removed and blank pixels have been interpolated. This image 230 may contain noise from text artifacts because some of the darker pixels around the text may not be identified as text in the initial thresholding step. This effect is a further reason for using a larger superset of the foreground in the initial thresholding step when estimating the background.

Finally, thresholding is performed based on the estimated background image 230 of FIG. 8. In one embodiment, the comparison between the preprocessed output image 224 of FIG. 7 and the background image 230 of FIG. 8 is performed by a method of Gatos. (See B. Gatos, I. Pratikakis, S. J. Perantonis, Adaptive Degraded Document Image Binarization, Pattern Recognition, Vol. 39, pp. 317-327, 2006, which is hereby incorporated by reference.) FIG. 9 illustrates an output image 240 after a complete binarization process has been performed on the image 216 of FIG. 5. In FIG. 9, text area 242 is well-identified from its background 244 even at the extremely warped areas near the edge 246 of the main document 248.

Post-processing can be performed during a later step. A threshold can be applied on the largest and smallest region and common instances of noise such as the large dark lines 250 around the edges of the main document 248 can be removed.

The binarization step 110 previously described in connection with FIGS. 5-9, therefore, is capable of processing photograph image of an extremely warped document 218 that was captured under poor lighting conditions as an input, and successfully converting it to a binarized image 240 of the document with text area distinguishable from its background.

1.2. Text Regions Detection

After extracting the location of text pixels in an image, useful features of the original document, in particular, local horizontal and vertical text orientation can be identified. Then, vector fields can be built to model the text flow of the document. Note that in the image, the horizontal and vertical data are separate. While these directions are perpendicular in the source document, perspective transformation decouples them. These orientations at locations with distinct textual features can be identified and the orientations across the page can be interpolated to describe the surface of the entire document.

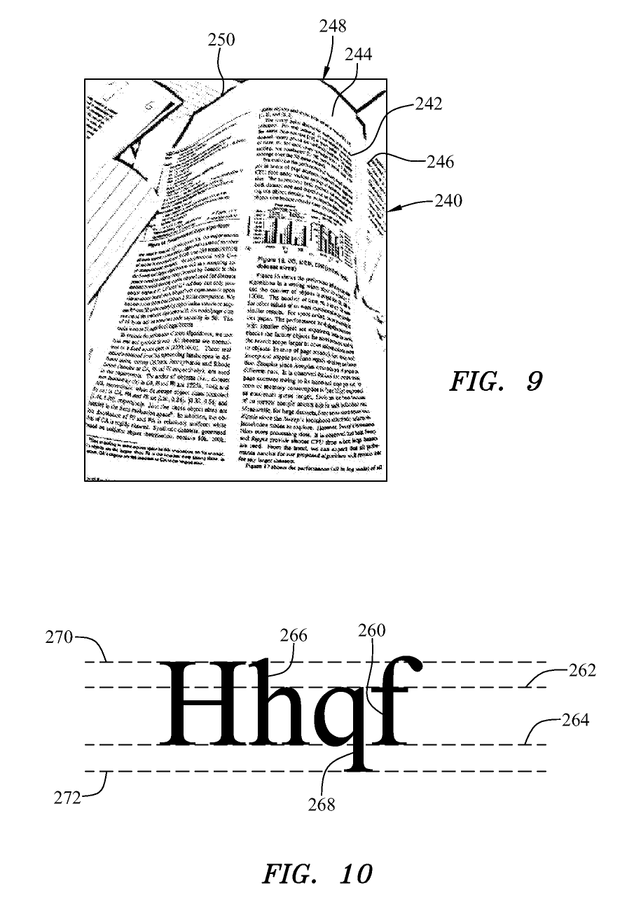

Referring to FIG. 10, languages that use the Latin character set have a significant number of characters containing one or more long, straight, vertical lines called vertical strokes 260. There are relatively few diagonal lines of similar length, and those that exist are usually at a significant angle from the neighboring vertical strokes. This regularity makes vertical strokes an ideal text feature to gain information about the vertical direction of the page.

To find the horizontal direction of the page, sets of parallel horizontal lines in individual text lines called rulings can be used. Unlike vertical strokes 260, these rulings are not themselves visible in the source document. Generally, the tops and bottoms of characters fall on two primary rulings called the x-height 262 and the baseline 264. The x-height 262 and baseline 264 rulings define the top and bottom, respectively, of the text character x. In some text characters, a part of the text character extends above the height of the text character x, as in d and h, is called an ascender 266. On the other hand, a descender 268 is referred to as a part of a text character which extends below the foot of the text character x, as in y or q. In the present embodiment, the x-height 262 and the baseline 264 are used as local maxima and minima (tip points) of character regions. These tip points are the “highest” and “lowest” pixels within a character region, where the directions for high and low are determined from the rough spline through the centroids of each character region in a text line. These tip points are later used in the curve fitting process, described in a separate section.

Two pixels are connected if they have the same color and are next to each other and share a common side. A character region is a group of black pixels that are connected. In this patent document, the term “connected component,” “connected region” or just “character region” are used interchangeable.

A properly binarized image should comprise a set of connected regions assumed that each corresponding to a single text character which may be rotated or skewed but does not evidence local curvature. The text region detection step 112 organizes all of the pixels that have been identified as text pixels during the previous binarization step into connected pixel regions. In the case where the binarization step was successful—the binarized image has low noise and the text characters are well resolved—each text character should be identified as a connected region. However, there may be situations in which groups of text characters are marked as contiguous regions.

In the present embodiment, Matlab's built-in region finding algorithm, which is a standard breadth-first search algorithm may be used to implement the text region detection step 112 and identify character regions.

1.3. Text Lines Grouping

The text lines grouping step 114 is used to group the character regions in the image into text lines. Estimations of the text direction are made based on local projection profiles of the binary image and available text directions generated during the grouping process. Preference is given to groups with collinear characters. Groups are allowed to be reformed as better possibilities are found. In other words, characters may be grouped into text lines using a guess-and-check algorithm that groups regions based on proximity and overrides previous groups based on linearity. For each text line, an initial estimation of the local orientations may be found by fitting a rough polynomial through the centroids of the characters. The polynomial fitting preferably emphasizes performance over precision, as the succeeding steps require this estimation but do not require it to be very accurate. Tangents of polynomial fittings are used for initial horizontal orientation estimation, and the initial vertical orientation is assumed to be perfectly perpendicular.

1.4. Centroid Spline Computing

In the centroid spline computing step 116, the location of the “centroid” of each character region of a text line is calculated. In the present embodiment, the centroid is the average of the coordinates of each pixel in the character region. Then, a spline through these centroid coordinates is calculated.

1.5. Noise Removal

After character regions are grouped into text lines, the location of the calculated splines can be used to determine which text lines do not correspond to actual text. These are character region groupings composed of extraneous pixels from background noise outside of the page borders that do not correspond to actual lines of text. In the present embodiment, noise is removed based on paragraphs/columns in this noise removing step 118.

Because text can be grouped into paragraphs, regions corresponding to paragraphs can be identified. Therefore, splines representing text lines that do not intersect with paragraph regions can be treated as noise rather than actual text lines and should be removed.

To identify regions corresponding to paragraphs, it may be assumed that in a paragraph, a text line is parallel to text lines immediately above or below, and these lines have roughly the same shape and size. Additionally, it may be assumed that the vertical distance between text lines is constant.

Polygonal regions containing paragraphs may thus be identified by using dilate and erode filters. The dilate filter expands the boundaries of pixel regions, while the erode filter contracts the boundaries of pixel regions. These filters make use of different structuring elements to define exactly how filters affect the boundaries of regions. Circles can be used as structuring elements, which expand and contract regions by the radius of the circles.

In the present embodiment, the noise removing step 118 is preferably performed in the following sequence. First, the size for the structuring element is determined based on the distance between text lines. By expanding the text line distance, regions can be formed such that each pair of adjacent text lines is enclosed in a single region, effectively placing paragraphs into regions. Next, an erode filter may be used to double the text line distance to eliminate regions that are thin or far from the main paragraphs. The dilate filter may then be used is used to ensure remaining regions enclose the corresponding paragraphs. Next, all regions with area less than a predetermined factor of the area of the largest region may be discarded to remove remaining noise regions. In one embodiment, the predetermined factor is one-fourth. Once the regions containing paragraphs are identified, all splines that do not intersect these regions can be removed, thereby leaving behind only slice lines that correspond to true text lines.

Though the removal process described above may occasionally remove valid text lines such as headers and footers, the paragraphs should contain enough information regarding the shape of the page for further processing.

2. Shape and Orientation Detection

The shape and orientation detection step 104 identifies typographical features and determines the orientation of the text. The identified features are points in the text that correspond to the tops and bottoms of text characters (tip points) and the angles of the vertical lines in the text (vertical strokes). These features may not be present in every single character. For example, a capital O has neither vertical strokes nor x-height tip points. Also, curves are fit to the top and bottom of text lines to approximate the original document shape.

In the present embodiment, five sub-steps are performed in the shape and orientation detection step 104. These sub-steps are tip point detection step 120, splines fitting step 122, page orientation detection step 124, outliners removing and vertical paragraph boundaries determination step 126, and vertical strokes detection step 128.

2.1. Tip Points Detection

As previously mentioned, the tip points of a character are the top and bottom features within the character, making them local minima or maxima within an identified character region. They tend to fall on the horizontal rulings of text lines. In the present embodiment, tip point detection step 120 is used to find the horizontal orientation in a text document because the tip point is a well-defined feature of a character region. Tip points can be identified on a per-character basis from the thresholded character regions and the centroid spline of the text line.

To find the local maximum and minimum within an identified character region, the orientation on the character region is defined with respect to which the maximum and minimum are found. This orientation can be approximated by the angle of the centroid spline through the character. The approximation can have a high error because tip points in a character region are robust with respect to the original orientation selected. For tip points at the top and bottom of vertical strokes, an error of up to 90° in the character orientation would be required to falsely identify the tip point. Tip points at the top of diagonal strokes can still be accurately identified if the character orientation has an error of up to 40°. Tip points lying at the top of curved characters such at the text character “o” are more sensitive to errors in orientation, because even a small error of a few degrees will place the tip point in a different location on the curve. However, such an error does not change the height of the identified tip point by more than a few pixels.

Before finding the tip points, the approximate orientation should be known. A change of coordinates can be performed on each region's pixels where the new y-direction, y′, is given by the orientation and the new x-direction, x′, is perpendicular to the y′ direction. This can be achieved by applying a rotation matrix to the list of pixel coordinates. In other words, the new pixel coordinates are represented by floating-point numbers as opposed to the original integer coordinates. The x′ coordinate can be rounded to the nearest integer to group pixels into columns in the rotated space.

In order to find the global extrema in a character region, the pixel with maximum or minimum y′ coordinate should be identified. A significantly larger portion of the global extrema fall on the cap-height line 270 as shown in FIG. 10, making it difficult to distinguish either ruling with accuracy if only global extrema are considered. On the other hand, finding the local extrema in the character region could produce a better result generally. Most of the local maxima are on the x-height ruling, making the ruling easy to find.

In order to separate top tip points from the bottom tip points, the character region can be first split in half along the centroid spline. Only points above the centroid spline are likely to be local maxima which are on the x-height ruling. And only points below the centroid spline are likely to be local minima, which are on the baseline ruling. Within each half, the local extrema are identified by an iterative process that selects the current global extrema and removes nearby pixels as described in more detail in the next paragraph.

Beginning with an identified tip point, the iterative process finds the highest pixels in the neighboring two pixel columns that are not higher than the tip point itself and then deletes everything else in the tip point's column. It then iterates on the pixels in the neighboring columns, treating the top of that column as another tip point for the purpose of removal. In this fashion, pixels from the character in the direction of the character orientation may be removed, thereby preserving other local extrema. The process then repeats, using the new global extremum in the smaller pixel set as the new tip point.

2.2. Splines Fitting

In the splines fitting step 122, splines are fitted to the top and bottom of text lines. After tip points described in the previous Section are obtained, tip points can be filtered and splines can be fitted to tip points. Splines are used to model the baseline 264 and x-height 262 rulings of each text line for indicating the local warping of the document.

Splines can be used to smoothly approximate data in a similar manner as high order polynomials while avoiding problems associated with polynomials such as Runge's phenomenon (See Chris Maes, Runge's Phenomenon, http://demonstrations.wolfram.com/RungesPhenomenon, 2007, which is hereby incorporated by reference.) In the present embodiment, splines are piecewise cubic polynomials with continuous derivatives at the coordinates where the polynomial pieces meet. If decreasing of the fitting error is desired, in the present embodiment, the number of polynomial pieces are increased instead of increasing the order of the polynomials.

In the present embodiment, approximating splines are used that pass near the tip points rather than pass through them.

An example of a spline is a linear spline (order two). In a linear spline, straight line segments are used to approximate the data. However, this linear spline lacks smoothness because the slopes are discontinuous where segments join. Splines of a higher degree can fix this problem by enforcing continuous derivatives. A cubic spline S(x) of order 3 with n pieces can be represented by a set of polynomials, {Sⱼ(x)}, which is defined on n consecutive intervals Iⱼ:

Sⱼ(x)=+a_{0,j}+a_{1,j}x+a_{2,j}x²+a_{3,j}x³∀×ΕIⱼ

where a_{i,j} are coefficients chosen to ensure that the spline has continuous derivatives across the intervals.

In the present embodiment, spline fitting addresses the issues of speed and accuracy by performing the process described hereafter. First, the orientation of the document is identified by employing the knowledge that outliers mostly occur on the top half of text lines when the text uses the Latin character set. Knowing the orientation makes it possible to use different algorithms for fitting splines to the bottom and top of text lines.

In the present embodiment, a median filter is applied to the bottom tip points to reduce the effect of outliers. A small window is used for the filter since that there are less outliers on the bottom half of a text line and those outliers tend not to be clustered in English text. A spline that is fitted to this new filtered data set is called the bottom spline. Next, the top tip points are filtered using the distance from the bottom spline and the median filter with a large window size. This reduces the impact of the larger number of outliers on the top portion of the text line and ensures that the top and bottom splines are locally parallel.

As described previously, before splines are fitted, top and bottom tip points are filtered by using the median filter.

Regarding the bottom tip points filtering, in the present embodiment, the bottom tip points are filtered using a median filter with a small window size w. In the present embodiment, w is set to be 3. The points are ordered by their x-coordinate values. Then the y-coordinate value of each bottom tip point is replaced by the median of the y-coordinates of neighboring points. For most points, there are 2w+1 neighbors, including the point itself. These are found by taking w points to the left and w points to the right of the tip point in the ordered list. The first and last tip points are discarded because they lack neighbors on one side. Other tip points whose distance from either end of the list is less than the window size should have their window size changed to that distance. This ensures that at any given tip point, there is always the same number of points to the right and left for computing the median. There is also an additional benefit for selecting 2w+1 points (an odd number), namely, that the median of the y-coordinate value will always be an integer.

Regarding the filtering of top tip points, in the present embodiment, an approach different from that of the bottom tip points filtering is used. Because English text contains more outliers in the top tip point data. The distances between the y-coordinates of the top tip points and the bottom spline at the corresponding x-coordinates is considered. Because the bottom spline is generally reliable, these distances should be locally constant for non-outlier data in large neighborhoods. Consequently, the median filter with a large window size is applied to these distances to remove the outliers. The y-coordinate of each top tip point is replaced with the sum of the median distance at that point and the y-value of the bottom spline at the corresponding x-coordinate.

Once the top and bottom tip points are filtered, two splines can be fitted to each text line. In the present embodiment, a bottom spline is fitted to the filtered bottom tip point dataset and a top spline is fitted to the filtered top tip point dataset. The same approximating splines for both purposes are used. All points can be weighted equally, the splines can be cubic (order 4) and the number of spline pieces is determined by the number of character regions in a text line. Typically, each character region corresponds to one text character. In some occasion, several text characters or a word could be blurred together into one region. In one embodiment, the number of spline pieces is set to the ceiling of the character regions divided by 5, with a required minimum of two pieces.

The splines for each text line are found independently from other text lines. However, information from neighboring text lines can be used to make splines more consistent with one another. This information can also be used to find errors in text lines when the found lines span multiple text lines.

The top splines for determining the local document warping can be ignored, since the data from the bottom splines is usually sufficient to accurately dewarp the document. This is because a text line that has several consecutive capital text characters at the beginning or end of a text line, these characters may contribute a large number of tip points above the x-height line 262 that would not be removed as outliers by the median filter. Thus, splines will incorrectly curve up to fit the top of the capital text characters. It is still preferably that the top spline be calculated, however, because the top spline does give other useful information about the height of text lines.

2.3. Page Orientation Determination

There are four possible orientations of a document: east) (0°), north (90°), west (180°), or south (270°). This is the general direction that an arrow drawn facing upward on the original document would be pointing in the image. The number of horizontal splines is compared to the number of vertical splines to determine if the orientation is in the north/south or east/west category. Since top and bottom splines are different, it is necessary to distinguish between north and south or between east and west to know which half of a text line is the top half. This may be accomplished by employed the observation that in English, and other languages that use the Latin character set, there are more outliers on the top half than the bottom half of text lines due to capital text characters, numbers, punctuation and more characters having ascenders than descenders.

Thus, to distinguish between the top and the bottom of a document, in the present embodiment, a representative sample of text lines whose length is close to the median length of all text lines is chosen. For each text line in the sample, the top is found by checking which side has more outliers. This can be done by applying the bottom spline fitting algorithm to both the top and bottom sets of tip points and measuring the error in these fits. In one embodiment, orientation is determined when the number of text lines producing equivalent orientations, is at least 5% of all text lines in the document, and surpasses the number of text lines producing alternative orientations by at least two. This ensures orientation detection should be accurate over 99% of the time.

Regarding the text line selection, a typical document contains 100 to 200 text lines. Thus, ideally, only a very small sample of these is used for the orientation computation step, which is significantly slower than regular spline fitting. Generally, between 5 and 10 text lines are required to conclusively determine the orientation, but this number can vary because of the “win by two” criterion. In the present embodiment, to reduce the number of errors resulting from noise, the text lines are first ordered based on their length. Text lines that are too short or too long are more likely to be a noise, and long text lines tend to give more accurate results than short text lines. The average and the median length of all text lines are calculated and the maximum of these two numbers is considered to be the optimal line length. Then all text lines are ordered based on the difference between their lengths and the optimal line length. Thus reasonable length of text lines are considered before outliers.

Regarding error metrics, after a spline is fitted to the top and bottom of each text line, the errors of these two fits can be compared. The error of a fit is calculated by considering the error at each tip point. The error at a tip point is the difference between the y-coordinate of that point and the value of the spline function at the corresponding x-coordinate. These point-wise errors may be summed and scaled by the number of tip points used to compute the error of the fit.

Since the assumption that the top spline has more outliers arises from the assumption that characters are from a Latin alphabet, the method may need to be modified for other character sets. Thus, a threshold is set on how large the difference in error of the fits needs to be in order to conclude the orientation of a text line. This threshold ensures that an assumption regarding the orientation of a document is not incorrectly made when orientation cannot be properly determined. If the threshold is not met, the text is considered as right side up or rotated 90° clockwise. Once the orientation can be determined, the dewarping step can be used to correctly rotates the image.

Parameters chosen for the implementation of the present embodiment are hereafter listed: (1) The window size for median filter of bottom spline is set at 7. This value was chosen because there are approximately two tip points found per text character, so the window encompasses one text character to the right and one text character to the left of the tip point. (2) The window size for median filter of top spline is set at 21. This value was chosen to be much greater than the window size for the bottom spline to make the filtering more severe on the top tip points. (3) The number of spline pieces per line is set to be the ceiling of the number of character regions divided by 5, which requiring at least two spline pieces per line. (4) The minimum number of regions in a valid text line is set to 5 to ensure that there are enough data points to define a spline.

2.4. Outliers Removing and Vertical Paragraph Boundaries Determination

The outliers removing and vertical paragraph boundary determination step 126 will now be described. At this point, connected text regions have been identified and grouped into potential text lines. For each potential text line, the centroid for each connected region of pixels is computed. Then, the approximate orientation for each text line is computed. Text lines whose orientations are very different from the majority of other text lines are discarded. Text lines that are significantly shorter than other text lines are also discarded. In one embodiment, Matlab's “clustercentroids” function is used to implement the outliers removing process.

After the erroneous text lines are eliminated, the start and end points of each text line can be collected. A Hough Transform may be used to determine if the start points of the text lines line up—if they do, then a line describing the left edge of a paragraph has been found. Similarly, if the end points of the text lines line up, then the paragraph was right justified and the right side of the paragraph has been found. If these paragraph boundaries are found, they will be used to supplement the vertical stroke information (collected later in the algorithm) in the final grid building step 132. More weight is given to this paragraph boundary information than the vertical stroke information in the final grid building step 132.

2.5. Vertical Stroke Detection

In the present embodiment, the vertical stroke detection step 128 is performed by first intersecting the centroid spline of a text line with the text pixels. At each intersection point, approximately vertical blocks of pixels are then obtained by scanning in the local vertical direction. The local vertical direction of each block may be estimated with a least squares linear fit. The set of obtained pixels are then filtered with fitted second degree polynomials, favoring linearity and consistency of orientation among detected strokes. Outliers to the fitted polynomials can be removed from consideration. In one embodiment, outliers are removed by using a hand-tuned threshold of 10°. Then, the results can be smoothed by using average filters.

Alternatively, outlines may also be used to find vertical stroke, especially as camera resolution improves. Larger pixel sets are proven more amenable to analyzing the border instead of the interior. This is because that larger pixel sets have a more well-defined border and the size of the interior grows faster than the size of the border.

3. Image Transformation

In the present embodiment, two sub-steps are performed in this image transformation step 106. These sub-steps are an interpolation creating step 130 and a grid building and dewarping step 132.

In the grid building and dewarping step 132, extracted features are used as a basis to identify the warping of the document. A vector field is generated to represent the required horizontal and vertical stretch of the document image at each point. Alternatively, the grid building and dewarping step 132 can be replaced by an optimization-based dewarping step 134.

3.1. Interpolator Creating

In the interpolator creating step 130, interpolators are created for vertical information from vertical strokes and the horizontal information from top and bottom splines. In the present embodiment, the dewarping of imaged documents is performed by applying two dimensional distortions to the imaged document. The distortions are local stretchings of the imaged document with the goal of producing what appears to be a flat document. How much an imaged document should be stretched can be determined locally based on data from local extracted features. These features can be the 2D vectors in the imaged document that fit into one of two vector sets. Vectors of the first set are parallel to the direction of the text in the document while vectors in the second set are parallel to the direction of the vertical strokes within the text of a document. In a warped document of the original image, vectors in these sets may point in any direction. It is desired to stretch the image such that these two sets of vectors become orthogonal, with all vectors in each set pointing in the same direction. The vectors parallel to the text lines should all point in the horizontal direction, while the vectors parallel to the vertical strokes should all point in the vertical direction.

The parallel vectors can be extracted by calculating unit tangent vectors of the text line splines at regularly spaced intervals. Also, the vertical strokes from each text line can be extracted by looking for a set of parallel lines corresponding to dark lines in the text that are approximately normal to the centroid spline of each text line. Each vertical strokes can be represented as a unit vector in the location and direction of the stroke. The angle of each vertical stroke can be estimated by using the least squares linear regression. Here, the parallel vectors are referred to as the tangent vectors and the vertical stroke vectors as the normal vectors. Note that normal vectors are normal to the tangent vectors in the dewarped document. However, in the original image of the document, perspective distortion and page bending cause the angle between these vectors to be more or less than 90°.

The basic interpolating process is described hereafter. The first step is to interpolate the tangent and normal vectors across the entire document. This is essential for determining how to dewarp the portions in an image where there is no text, or the text does not provide useful information. A Java class can be used for storing known unit vectors (x, y, θ). Once an object of this class gathers all the known vectors, the angle θ of an unknown vector at a specified location (x, y) can be obtained by taking a weighted average of the nearby known vectors in the local neighborhood of (x, y). This can be complicated since θΕ (π, −π]. Normal interpolation techniques do not necessarily work, since one angle at π−ε is very close to another angle at −π+ε (where ε is some very small number). The angle is calculated by a weighted average of known vectors where the weight of each known vector v is computed using the following function.

$$w ( d ) = \frac{1}{1 + {e}^{10 d / r - 5}}$$

where r is the radius of the neighborhood and d is the distance between v and (x, y).

Note that d<r, therefore, as d approaches r, w(d) becomes very small. As d approaches 0, w(d) becomes very close to 1. In the present embodiment, the constants (the 10 and 5) in the equation are used to normalized the values of weight between 0 and 1 in a smooth fashion. These values could be changed to alter the results. The parameter r determines the radius of influence of vectors. The parameter r can be arbitrarily set at 100 pixels. However, other numbers can be used since that if there is no vector within the neighborhood, the search continues beyond the neighborhood with a very low weight assigned to any discovered vectors. The parameter r can be arbitrarily selected because that the underlying data structure is a kd-tree, which supports fast nearest neighbor searches. For more information on kd-trees, see Jon Louis Bentley, K-d trees for Semidynamic Point Sets, in Proceedings of the Sixth Annual Symposium on Computational Geometry, pp. 187-197, 1990.

The basic interpolation process previously described works fairly well for areas of documents that are dense in the number of extracted features. However, when two dense areas are separated by a sparse area, abrupt changes rather than smoothly interpolating may be shown through the sparse area. A perfectly smooth interpolation is not desired because that can lead to incorrect results when one document is partially occluding another. On the other hand, discontinuities is also not desired when all areas in question are part of the same document.

Therefore, using an exponential function as the basis for the weight function could allow a partially achievement of this behavior. This limits the influence of vectors under normal circumstances to the default radius of the search neighborhood.

The interpolation process achieves basic outlier removal as well. Once the interpolation object stores all known vectors, each vector is removed from the interpolation object and the object is queried for the interpolated value at that point. If the actual vector and the interpolated vector differ in angle by more than a certain threshold, the vector is not added back into the interpolation object. The threshold can be 1°, which ensures all vectors used to dewarp are consistent with those around it. Most of the errors in vectors are removed due to incorrect feature extraction. This method may result in too much smoothing, since it discourages abrupt changes in the vectors.

The preferable embodiment of interpolation is described below. This interpolator creation step 130 is based on fitting two dimensional surfaces to vector fields. Starting from the nth degree polynomial functions, the method of the least squares error is used to fit a surface to the horizontal and vertical vector fields. These functions may oscillate at the edges of the image due to the Runge's phenomenon. This problem can be solved by replacing the high degree polynomials with two dimensional cubic polynomial splines.

Regarding the vertical interpolation, after some vertical strokes which represent the tangents to the vertical curvature of the document are found, this information across the image can be interpolated. In the present embodiment, vertical interpolation is performed by constructing a smooth continuous function that best approximates the vertical data.

As to angles, the vertical stroke data can be represented as the angle of each vertical stroke coupled with its coordinates. This representation could be complicated because of the modular arithmetic on angles which makes basic operations, such as finding an average. This problem can be solved by making the assumption that all angles are within plus or minus 90° from the average horizontal and average vertical angle of the document (for the tangent and vertical vector fields respectively). All angles are moved into these ranges and assume that the surfaces will not contain any angles outside these ranges. This assumption is true for any document that has not been bent through more than 90° in any direction.

Once the angles are constrained to the proper range, they can be treated as regular data without worrying about modular arithmetic.

Regarding the horizontal interpolation, the splines that fit to the top and bottom of text lines follow the horizontal curvature of the document. The angles of the tangents can be extracted to the splines at each pixel and a smooth continuous function that best approximates this horizontal tangent data can be constructed. As with vertical interpolation, angles are first moved into an appropriate range and then treated as regular data. This range is obtained by adding 90° to the vertical angle range.

The next step is to find an interpolating function that best approximates this data. A notable characteristic of the data of the present embodiment is that it is not defined on a grid, but scattered across the image. First, two dimensional high order polynomials can be used as interpolating functions. Then, thin plate splines can be treated as an alternative interpolation technique that may handle non-gridded data more elegantly.

Regarding 2D polynomials, the goal is to fit an nth degree polynomial to the data using the least squares method. An over-determined linear system of equations is set up to find the coefficients of the polynomial. The polynomial has the form p(x, y)=a₀xⁿyⁿ+a₁xⁿyⁿ⁻¹ . . . +a₍ₙ₊₁₎²x⁰y⁰. At each data point with coordinates (xᵢ, yᵢ) and angle θᵢ, the equation p(xᵢ, yᵢ)=θᵢ can be obtained, where the coefficients aⱼ are unknown. Repeating this for each of M data points, a linear system of equations can be obtained with N equations and (n+1)² unknowns. It is found that n=10 and n=30 is sufficient for vertical and horizontal data, respectively. Approximately N=10000 data points can be expected so this creates an over determined system. In the present embodiment, the backslash operator in Matlab is used to solve the over-determined system because the least squares error method had numerical instability issues for n>20.

The goal here is to find the constants on the nth order polynomial that minimizes the sum of the errors at all the data points. The error function can be written as E=Σᵢ(θᵢ−p(xᵢ, yᵢ))², where the sum is across all data points (xᵢ, yᵢ) that have an angle θᵢ associated with them, and p is the unknown polynomial function of degree n. If the function has constants aᵢ, . . . , a₍ₙ₊₁₎², it is desired to minimize the error with respect to those constants. Therefore, let dE/daᵢ=0 for all aᵢ. a system of n equation with n unknowns can be obtained. It also happens to be a linear system. Thus, what needs to be solved is Mₓ=b for an unknown vector x containing the coefficients aⱼ. M is an n by n matrix and b is a vector of length n. The matrix M happens to be symmetric positive definite, so the system can be solved by using Cholesky factorization and thus obtain the coefficients of the polynomial.

In case the polynomial exhibits Runge's phenomenon and begin to oscillate wildly around the edges of the image, especially when the image is sparse in data outside the center, it can be solved by dividing the document into a grid and adding a data point containing the document angle in each grid cell that has no data.

Alternatively, two dimensional cubic spline interpolation can be used as the high order polynomial interpolation because it avoids Runge's phenomenon. Matlab's 2D cubic spline function can only be used on gridded data. The values on a grid should be found so that the generated cubic spline over that grid can best approximate the data.

In the present embodiment, a 10 by 10 grid is used for vertical interpolation, and a 30 by 30 grid is used for horizontal interpolation to obtain a finer resolution. It is required to generate a set of n² spline basis functions eᵢ which are splines over an n×n grid containing all 0's, and a 1 in the ith cell. The spline over an n×n grid containing values aᵢ in the ith cell is equal to Σᵢ aᵢeᵢ. The error function for the spline is

$$E = {\sum }_{\vec{x}} {( {\sum }_{i} ( {a}_{i} {e}_{i} ( \vec{x} ) - θ ( \vec{x} ) ) )}^{2}$$

where θ(\vec{x}) is the angle \vec{x}ᵢ.

It is desired to find the coefficients aᵢ that minimize the error function. However, if there are grid cells that do not contain any data, the spline behavior in those cells may not constrained. Therefore, in the present embodiment, a small constraining term e=Σ_{i,j adjacent cells}ε(aᵢ−aⱼ)² is added to the error function. This makes the coefficient which is at grid cell i with no data points, to be equal to the average coefficient of aⱼ of the four adjacent grid cells of i. In one embodiment, e is set to be slightly high to also constrain the cells that contain few data points. The new error function can be written as:

$$E = {\sum }_{\vec{x}} {( {\sum }_{i} ( {a}_{i} {e}_{i} ( \vec{x} ) - θ ( \vec{x} ) ) )}^{2} + {Σ}_{i , j adjacent cells} {ɛ ( {a}_{i} - {a}_{j} )}^{2}$$

Which produces an over determined linear system of equations. In one embodiment, this system is solved with Matlab. Finally, a spline over this grid with values aᵢ in the ith cell is generated and can be used to interpolated the original data.

3.2. Grid Building and Dewarping

In the present embodiment, the grid building and dewarping step 132 involves building a grid with the following properties. (1) All grid cells are quadrilaterals. (2) The four corners of a grid cell must be shared with all immediate neighbors. (3) Each grid cell is small enough that the local curvature of the document in that cell is approximately constant. (4) Sides of a grid cell must be parallel to the tangent or normal vectors. (5) Every grid cell across the warped image corresponds to a fixed-size square in the original document.

The process begins with placing an arbitrary grid cell in the center of the image. The grid cell is rotated until it meets the fourth criterion above. Then, grid cells can be built outward, using the known grid cells to fix two or three corner points of the grid cell to be built. The final point can be computed by querying the interpolation objects for the tangent and normal vectors at that location and then stepping in that direction.

In most cases, three corner points of a grid cell to be built are already known. Therefore, the two sides of the grid cell to be built may intersect at exactly one point, which can be used to determine the fourth corner point of the grid cell to be built. When a grid cell to be built is added directly horizontally or vertically from the center cell, only two corner points are known. In this case, the process can be somewhat arbitrary.

The grid building and dewarping step 132 can be performed better if a couple of problems associated with the grid building process are handled well. The first problem occurred when it is required to determine how much and where to stretch text horizontally. Once the tangent vectors and vertical strokes are correctly identified, the document can be dewarped with straight text lines. However, unless text characters are stretched horizontally to different degrees along each text line, the document may not look aesthetically pleasing. Text characters on page sections curving with respect to the camera will appear horizontally distorted, having a narrower width. While text characters on relatively flat sections of the paper will appear normal. In one embodiment, additional code to measure and correct for this stretching can be used to resolved this problem when horizontally stretched nature of text with very accurate tangents and normal vectors.

The second problem is that the grid building process builds the grid outward from some center cell. This means that any small errors in the tangents and vertical strokes will be propagated outward through the entire grid. A small error early in the grid building process can cause major grid building errors, expanding or shrinking grid cells abnormally. In one embodiment, building multiple grid cells can be used to solved the problem.

3.3. Optimization-Based Dewarping

Alternatively, an optimization-based dewarping step 134 can be performed as the final dewarping transform step 106. The optimization-based dewarping step 134 finds a mapping that determine where each pixel in the output image should be sampled from an original image. The dewarping function computes the mapping in a global manner, distinguishing it from grid-building.

In the present embodiment, optimization-based dewarping step 134 is performed in two steps. First, a number of subsets of pixels in the input image are considered and where these pixels should be mapped into the output image are determined. These pixels are called control points. The problem is framed as an optimization problem, which specifies properties of an ideal solution and search the solution space for the optimal solution.

Second, once a set of control points are obtained in the input image, smoothly interpolation can be performed across them to determine where every point in the original image should be mapped. This determines a natural stretching of the original image from the text features. Interpolation can be accomplished by using thin plate splines.

To construct the optimization function, a set of points in the original image are first found that can be easily mapped to the output image. It is better that this set of points are well distributed throughout the input image. In the present embodiment, a fixed number of evenly spaced points along each text line are selected.

An optimization problem can be set up to find where these points should be mapped to the output image. The optimization problem consists of an error function that estimates the error in a possible point mapping. This error function is also known as the objective function. In one embodiment, Matlab's implementation of standard methods for minimizing error in optimization problems can be used to find an optimal solution.

The objective function considers several properties of text lines in order to compute the error of a possible point mapping. For example, in a good mapping, all points in the same text line lie along a straight line, adjacent text lines are evenly spaced, and text lines are left-justified.

Once the objective function have been used to determine a mapping of control points from the output image to the input image, thin plate splines can be used to interpolate a mapping for the other pixels.

In the present embodiment, the mapping of these control points is used to generate a mapping for the entire image by modeling the image transformation as thin plate splines. Thin plate splines are a family of parameterized functions that interpolate scattered data occurring in two dimensions. They are commonly used in image processing to represent non-rigid deformations. Several properties of thin plate splines make them ideal for the optimization-based dewarping. Most importantly, they smoothly interpolate scattered data. Most other two-dimensional data-fitting methods are either not strictly interpolative or require data to occur on a grid.

General splines are families of parameterized functions designed to create a smooth function matching data values at scattered data points by minimizing the weighted average of an error measure and a roughness measure of the function. (See Carl de Boor, Splines Toolbox User's Guide, The MathWorks Inc., 2006, which is hereby incorporated by reference.) The measure of error is the least square error at the data points. For scalar data occurring in R², the function can be viewed as a three-dimensional shape. One possible measure of roughness of the function is defined by the physical analogy of the bending energy of a thin sheet of metal:

$$R ( f ) = {\int }_{- ∞}^{∞} {\int }_{- ∞}^{∞} [ {\vert {f}_{xx} \vert}^{2} + 2 {\vert {f}_{xy} \vert}^{2} + {\vert {f}_{yy} \vert}^{2} ] d x d y .$$

By minimizing the sum of the roughness and the error measures, the spline matches the data with a minimal amount of curvature.

Thin plate splines are the family of functions that solves this minimization problem with rotational invariance. This family can be represented as a sum of radial basis functions centered at the data points plus a linear term defining a plane. A radial basis function φ(x) is a function whose value in R² is radially symmetric around the origin, so that φ(x)≡(|x|). The radial basis function for thin plate splines is φ(|x|)=|x|² log |x|. A thin plate spline f (x) fitted to n control points located at {xᵢ} has the form

$$f ( x ) = ax + by + c + {\sum }_{i} {k}_{i} φ ( x - {x}_{i} )$$

where a, b, c, and kᵢ are a set of n+3 constants.

Thin plate splines are general smoothing functions that trade off error and roughness. Strict interpolation can be recovered by allowing the weight on the error measure to approach 1 and the weight on the roughness measure approach 0. This is equivalent to only trying to minimize the roughness, with zero error. The general solution to this narrower problem is also a thin plate spline. (See Serge Belongie, Thin Plate Splines, http://mathworld.wolfram.com/ThinPlateSpline.html 2008, which is hereby incorporated by reference.) The specific problem of finding the constant weights for a given data set can be reduced to a determined system of linear equations. (See Carl de Boor, Splines Toolbox User's Guide, The MathWorks Inc., 2006, which is hereby incorporated by reference.) The reason for using strictly interpolating thin plate splines are discussed below.

While thin plate splines were originally designed for scalar data, they can be generalized to vector data values. By assuming the two dimensions of the data behave independently, each coordinate can be modeled using its own independent scalar thin plate spline function. This is the approach usually taken when using thin plate splines in image processing applications. (See Cedric A. Zala and Ian Barrodale, Warping Aerial Photographs to Orthomaps Using Thin Plate Splines, Advances in Computational Mathematics, Vol. 11, pp. 211-227, 1999, which is hereby incorporated by reference.) A mapping from one two-dimensional image to another can be uniquely defined by some control points whose location in both images is known by using thin plate splines to interpolate the mapping for all other points. These control points found by the optimization problem. Two scalar thin plate splines are generated for the x and y coordinates in the input image and then evaluated at every point in the output image to find the corresponding pixels in the input image.

Because the control points in the input and output images are of the same data type, points in R², it is possible to use thin plate splines to define the transform in either direction. In a forward mapping process, the control points in the input image can be used as data sites, and the control points in the output image can be the data values. Evaluating the thin plate splines at a pixel in the input image, the location of that pixel mapped into the output image can be obtained. Such a transformation may have problems when it is used for discrete image matrices. In general, all of the output locations could be irrational real numbers rather than integers, so the exact pixel correspondence will be unclear. More importantly, if the transformation squishes or stretches the input image, several pixels may be mapped to the same spot, or some areas in the output image may fall in between pixels mapped by the original.

In the present embodiment, the reverse mapping, instead of the forward mapping, is used to avoid the problem of having undefined pixels in the output image. In the reverse mapping process, the controls points in the output image are the data sites and the control points in the input image are the data values. Evaluating the thin plate spline at a pixel location in the output image can return the pixel in the input image that it is mapped from. A non-integer answer can be interpreted as the distance-weighted average of the four surrounding integer points. Because every pixel in the image matrix can be unambiguously defined from one thin plate spline evaluation, generating the output image can be straightforward once the spline function is obtained.

Generating and evaluating thin plate splines can be computationally intensive for large numbers of control points. Some approaches can be used to speed up the process which have minimal impact on the resultant image when used on text documents. The first is to reduce the number of control points per thin plate spline by breaking the image into pieces and generating separate thin plate spline functions for each piece. The image can be partitioned into pieces of varying size recursively to limit the maximum number of control points in each spline. The runtime is not very sensitive to this parameter. However, Matlab uses a much slower iterative algorithm when the number of control points exceeds 728 (See Carl de Boor, Splines Toolbox User's Guide, The MathWorks Inc., 2006, which is hereby incorporated by reference.) In the present embodiment, the maximum number of control points is limited to 500.

Each section of image is dewarped and the sections are concatenated to form the complete output image. In general, the thin plate splines are not continuous at the boundaries when used in this fashion. However, the optimization model creates segments which tend to line up neatly. The dewarping on each piece uses the control points from an area about twice as large as the area of the actual output image. Since control points are pretty evenly spaced over a piece of text, two adjacent segments will share a good amount of control points near their common boundary. By requiring the thin plate splines to be a strictly interpolative fit, the two transformations correspond very well in a neighborhood of this boundary. While not an exact correspondence, the difference is usually far less than one pixel, creating no visible artifacts in the output image.

If further testing reveals that the segments are not lining up properly on their own, it is possible to force them to do so by using samples from one segment as control points for another. Evaluating the thin plate splines of one segment at regular intervals along the border of another segment, and using the results as control points for the second segment, will cause the two functions to coincide exactly on the sampled points, and the interpolation should cause them to match along the entire border. One potential disadvantage of doing this is that the result may depend on the order in which the segments are dewarped. The two segments have different dewarpings, but only one of them is being altered to fit with the other, so the ordering will affect the output image. Another option is to investigate standard image-mosaicking algorithms. Most of these also use thin plate spline algorithms, so they could probably be implemented as part of the segment transformation rather than as a post-processing effect.

The second improvement affects only the evaluation of thin plate splines, not the generation. Evaluating a thin plate spline on n control points requires finding n Euclidean distances and n logarithms. Performing this computation for every single pixel in an image is prohibitively slow. This can be omitted. If the document deformation is not too severe, the thin plate spline will also not have drastic local changes. The result of evaluating the thin plate spline is a grid of ordered pairs showing where in the original image that pixel should be sampled from. An accurate approximation of this grid can be obtained by evaluating the thin plate spline every few pixels and filling in the rest of the grid with a simple linear interpolation. In practice, the transformation is simple enough that a local linear approximation is accurate for a neighborhood of several pixels. Sampling the thin plate splines every ten pixels reduces the number of spline evaluations necessary by two orders of magnitude, with no apparent visual artifacts on a normal text document. Since ten pixels is around the minimum for recognizable characters and the feature detection step assumes the curvature is larger than a single character, this approximation should not adversely affect dewarpings. By combining these two optimizations, thin plate spline transformations can be obtained on standard-sized images in Matlab with a runtime on the order of one to two minutes.

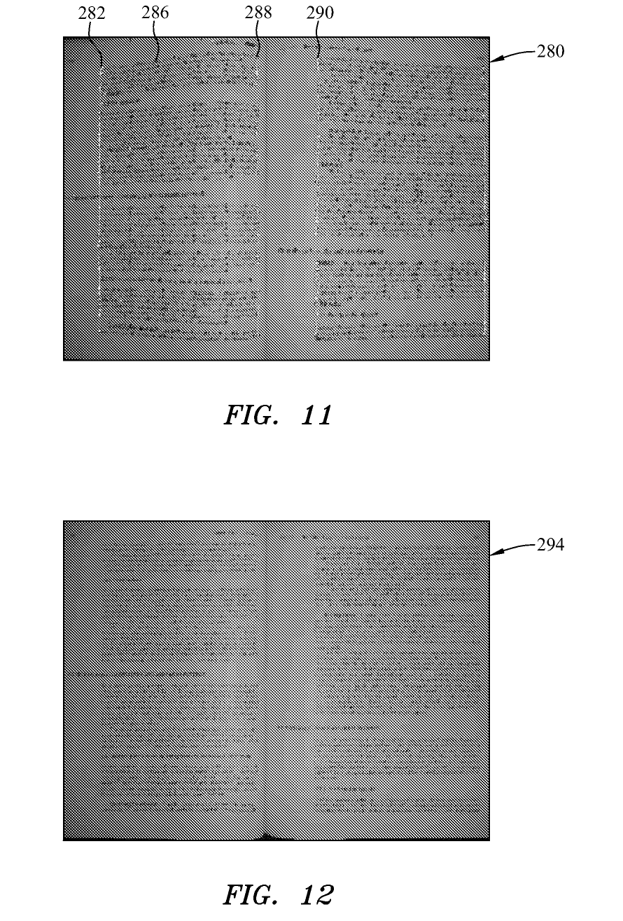

A sample image 280 dewarped using the optimization method is shown in FIG. 11. Control points 286 are marked in dark dots and those sets of points 282, 288 which will be horizontally justified are marked in light dots. This image 280 contains the sort of document with a high density of left- and right justified text.

Shown in FIG. 12, the output 214 of the optimization dewarping method applied to the sample image. The text lines have been mostly straightened and the columns left and right justified. Imperfections in justification arise from the fact that the points we align lie somewhere within the first and last text character in a way which is not necessarily consistent from line to line. The splines we fit to column boundaries could be used to get better sets of points to justify.

There are several other alternatives to grid building and dewarping step 132. One alternative is to apply a series of basic transformations to the entire image to correct for various types of warping. This approach would allow one to control which transformations are applied, specifying exactly what types of warpings we should correct for. However, this is also limiting, since the image can only be corrected if the original deformations can be expressed as some combination of these basic transformations. This approach could also be applied iteratively for smoother dewarping.

Another alternative is to fit splines between the text line splines across the entire page, using the splines to sample pixels for the output image. Each spline would represent a horizontal line of pixels in the output image. This method can benefit from using global optimizations between splines so that the splines are relatively consistent with each other.

Another alternative is to reconstruct the surface in 3D and to flatten the surface use an idea such as the mass-spring system discussed in Brown and Seales. (see Michael S. BROWN and W. Brent SEALES, Image Restoration of Arbitrarily Warped Documents, IEEE Transactions on Pattern Analysis and Machine Intelligence, Vol. 26, No. 10, pp. 1295-1306, October 2004, which is hereby incorporated by reference.)

The approaches described herein for processing a captured image are applicable to any type of processing application and (without limitation) are particularly well suited for computer-based applications for processing captured images. The approaches described herein may be implemented in hardware circuitry, in computer software, or a combination of hardware circuitry and computer software and is not limited to a particular hardware or software implementation.

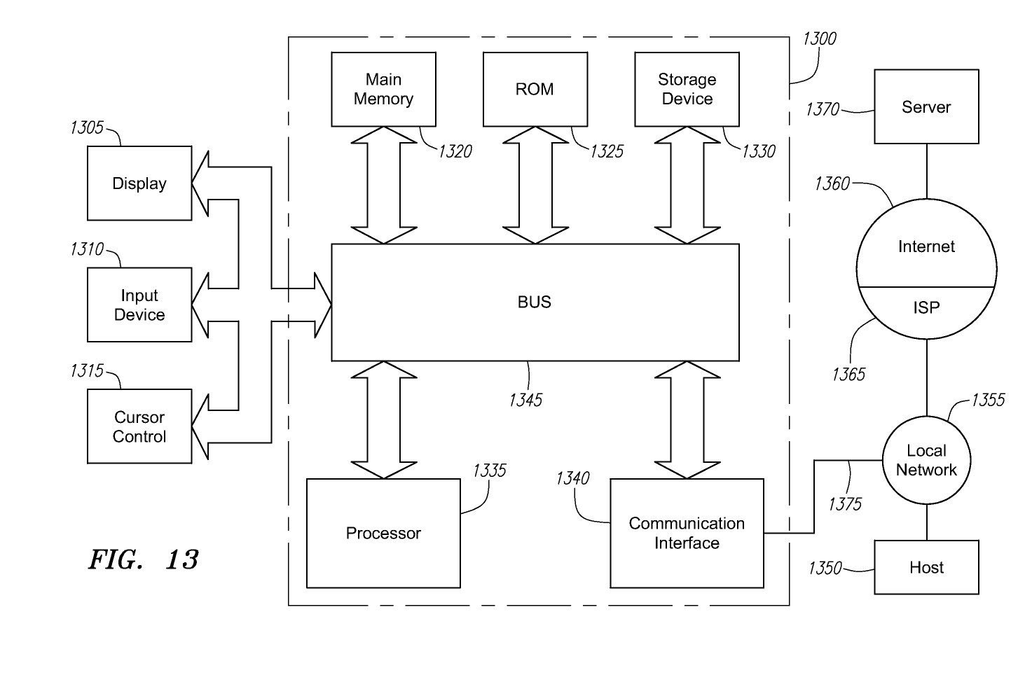

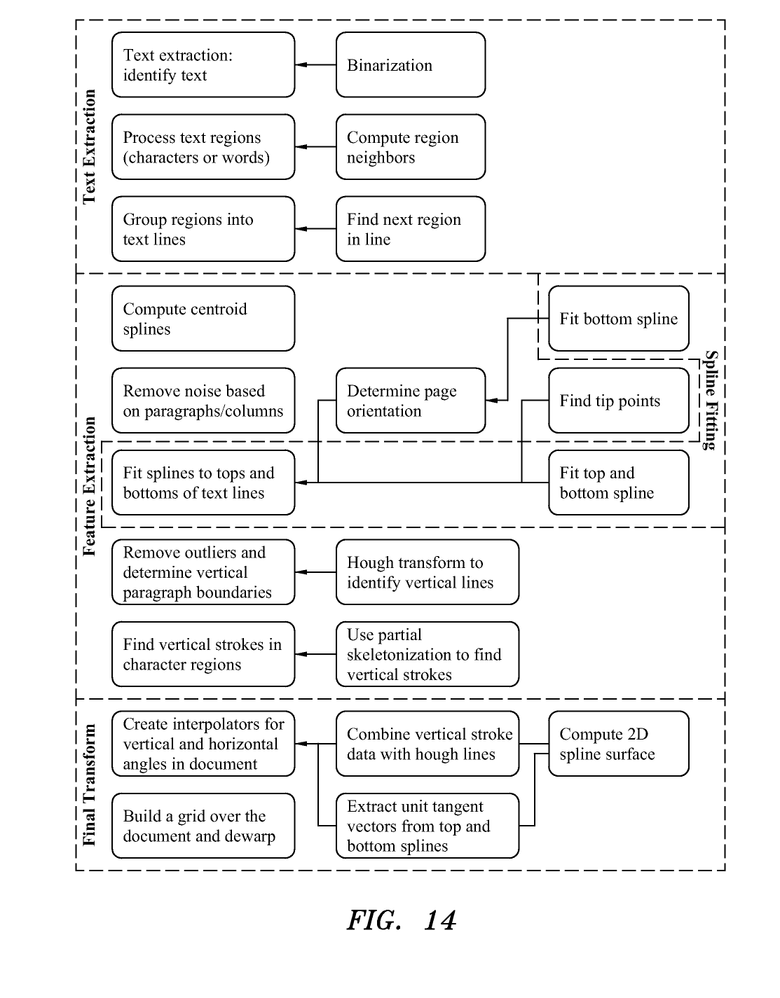

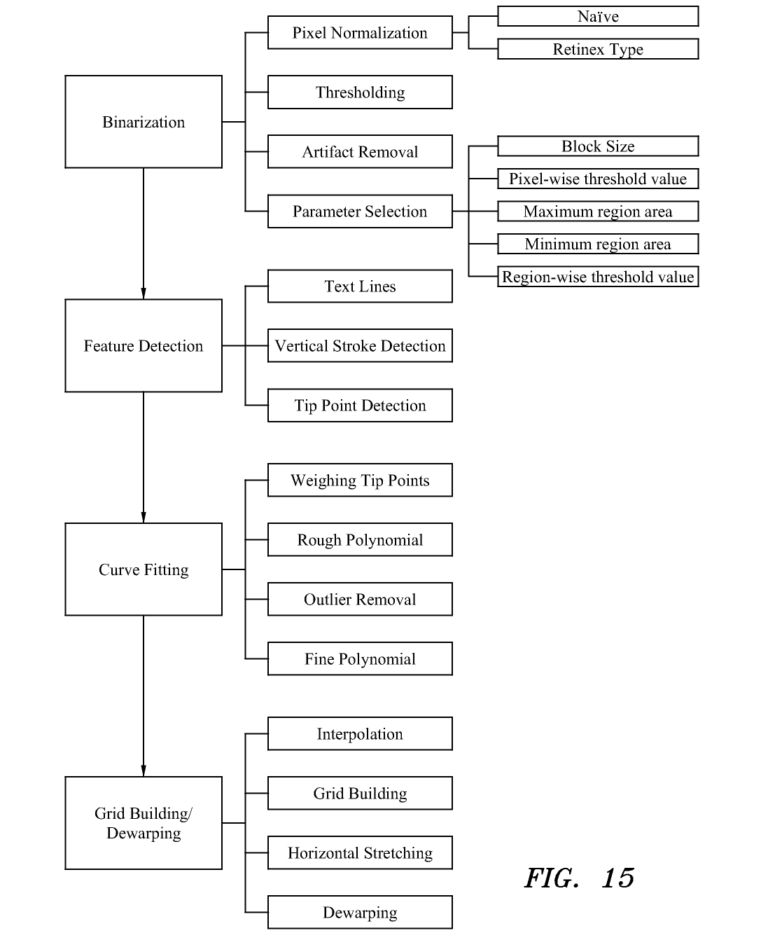

FIG. 13 is a block diagram that illustrates a computer system 1300 upon which the above-described embodiments of the invention may be implemented. Computer system 1300 includes a bus 1345 or other communication mechanism for communicating information, and a processor 1335 coupled with bus 1345 for processing information. Computer system 1300 also includes a main memory 1320, such as a random access memory (RAM) or other dynamic storage device, coupled to bus 1345 for storing information and instructions to be executed by processor 1335. Main memory 1320 also may be used for storing temporary variables or other intermediate information during execution of instructions to be executed by processor 1335. Computer system 1300 further includes a read only memory (ROM) 1325 or other static storage device coupled to bus 1345 for storing static information and instructions for processor 1335. A storage device 1330, such as a magnetic disk or optical disk, is provided and coupled to bus 1345 for storing information and instructions.

Computer system 1300 may be coupled via bus 1345 to a display 1305, such as a cathode ray tube (CRT), for displaying information to a computer user. An input device 1310, including alphanumeric and other keys, is coupled to bus 1345 for communicating information and command selections to processor 1335. Another type of user input device is cursor control 1315, such as a mouse, a trackball, or cursor direction keys for communication of direction information and command selections to processor 1335 and for controlling cursor movement on display 1305. This input device typically has two degrees of freedom in two axes, a first axis (e.g. x) and a second axis (e.g. y), that allows the device to specify positions in a plane.

The methods described herein are related to the use of computer system 1300 for processing a captured image. According to one embodiment, the processing of the captured image is provided by computer system 1300 in response to processor 1335 executing one or more sequences of one or more instructions contained in main memory 1320. Such instructions may be read into main memory 1320 from another computer-readable medium, such as storage device 1330. Execution of the sequences of instructions contained in main memory 1320 causes processor 1335 to perform the process steps described herein. One or more processors in a multi-processing arrangement may also be employed to execute the sequences of instructions contained in main memory 1320. In alternative embodiments, hard-wired circuitry may be used in place of or in combination with software instructions to implement the embodiments described herein. Thus, embodiments described herein are not limited to any specific combination of hardware circuitry and software.

The term “computer-readable medium” as used herein refers to any medium that participates in providing instructions to processor 1335 for execution. Such a medium may take many forms, including, but limited to, non-volatile media, volatile media, and transmission media. Non-volatile media includes, for example, optical or magnetic disks, such as storage device 1330. Volatile media includes dynamic memory, such as main memory 1320. Transmission media includes coaxial cables, copper wire and fiber optics, including the wires that comprise bus 1345. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1335 for execution. For example, the instructions may initially be carried on a magnetic disk of a remote computer. The remote computer can load the instructions into its dynamic memory and send the instructions over a telephone line using a modem. A modem local to computer system 1300 can receive the data on the telephone line and use an infrared transmitter to convert the data to an infrared signal. An infrared detector coupled to bus 1345 can receive data carried in the infrared signal and place the data on bus 1345. Bus 1345 carries the data to main memory 1320, from which processor 1335 retrieves and executes the instructions. The instructions received by main memory 1320 may optionally be stored on storage device 1330 either before or after execution by processor 1335.

Computer system 1300 also includes a communication interface 1340 coupled to bus 1345. Communication interface 1340 provides a two-way data communication coupling to a network link 1375 that is connected to a local network 1355. For example, communication interface 1340 may be an integrated services digital network (ISDN) card or a modem to provide a data communication to a corresponding type of telephone lines. As another example, communication interface 1340 may be a local area network (LAN) card to provide a data communication connection to a compatible LAN. Wireless links may also be implemented. In any such implementation, communication interface 1340 sends and receives electrical, electromagnetic or optical signals that carry digital data streams representing various types of information.

Network link 1375 typically provides data communication through one or more networks to other data services. For example, network link 1375 may provide a connection through local network 1355 to a host computer 1350 or to data equipment operated by an Internet Service Provider (ISP) 1365. ISP 1365 in turn provides data communication services through the world wide packet data communication network commonly referred to as the “Internet” 1360. Local network 1355 and Internet 1360 both use electrical, electromagnetic or optical signals that carry digital data streams. The signal through the various networks and the signals on network link 1375 and through communication interface 1340, which carry the digital data to and from computer system 1300, are exemplary forms of carrier waves transporting the information.

Computer system 1300 can send messages and receive data, including program code, through the network(s), network link 1375 and communication interface 1340. In the Internet example, a server 1370 might transmit requested code for an application program through Internet 1360, ISP 1365, local network 1355 and communication interfaced 1340. In accordance with the invention, one such downloaded application provides for processing captured images as described herein.

The received code may be executed by processor 1335 as it is received, and/or stored in storage device 1330, or other non-volatile storage for later execution. In this manner, computer system 1300 may obtain application code in the form of a carrier wave.

While examples have been used to disclose the invention, including the best mode, and also to enable any person skilled in the art to make and use the invention, the patentable scope of the invention is defined by claims, and may include other examples that occur to those skilled in the art. Accordingly the examples disclosed herein are to be considered non-limiting. Indeed, it is contemplated that any combination of features disclosed herein may be combined with any other or combination of other features disclosed herein without limitation.

Furthermore, while specific terminology is resorted to for the sake of clarity, the invention is not intended to be limited to the specific terms so selected, and it is to be understood that each specific term includes all equivalents.

It should also be understood that the image processing described herein may be embodied in software or hardware and may be implemented via computer system capable of undertaking the processing of a captured image described herein.

What is claimed:

1. A method for processing a photographed image containing text lines comprising text characters having vertical strokes comprising:
(a) binarization using pixel normalized thresholding to identify pixels in the image that make up the text;
(b) detecting typographical features indicative of the orientation of text;
(c) fitting one or more curves to a text line;
(d) building a grid of quadrilaterals using vectors that are parallel to the direction of the text lines and vectors parallel to the direction of the vertical stroke lines;
(e) dewarping the document by stretching the image so that vectors parallel to the text lines and vectors parallel to the direction of the vertical stroke lines become orthogonal; and
(f) processing the dewarped document with an optical character recognition software.

2. The method of claim 1, wherein the binarization process includes artifact removal that discards whole connected regions of black pixels if such a region exceeds a maximum area parameter.

3. The method of claim 1, wherein the binarization process includes artifact removal that discards whole connected regions of black pixels if such a region is less than a minimum area parameter.

4. A method for processing a photographed image containing text lines, the text lines comprise text characters having vertical strokes and top and bottom tip points, the method comprising:
(a) detecting the top and bottom tip points of the text lines;
(b) fitting one curve to the top tip points and one curve to the bottom tip points for each of the text lines;
(c) determining the page orientation of the photographed image by distinguishing the top and bottom portions of text lines;
(d) computing approximate orientation for each text line and removing outliners among text lines;
(e) finding vertical paragraph boundaries by determining whether the start points or end points of text lines are lined up;
(f) detecting vertical strokes in text characters by scanning in local vertical direction to obtain vertical blocks of pixels at each of the intersection point of a centroid spline of a text line with the text pixels of text characters;
(g) building a grid of quadrilaterals using vectors that are parallel to the direction of the text lines and vectors parallel to the direction of the vertical stroke lines; and
(h) dewarping the document by stretching the image so that vectors parallel to the text lines and vectors parallel to the direction of the vertical stroke lines become orthogonal.

5. The method of claim 4 wherein the determining the page orientation of the photographed image by distinguishing the top and bottom portions of text lines step further includes choosing a representative sample of text lines whose length is close to the median length of all text lines and, for each text line in the sample, checking which side has more outliers.

6. A method for processing a photographed image containing text lines comprising text characters having vertical strokes comprising:
(a) detecting typographical features indicative of the orientation of text;
(b) fitting one or more curves to a text line;
(c) building a grid of quadrilaterals using vectors that are parallel to the direction of the text lines and vectors parallel to the direction of the vertical stroke lines; and
(d) dewarping the document by computing for each pixel location of the output image, its corresponding location in the input image; and its pixel color and/or intensity by using one or more pixels near the corresponding location in the input image.

7. The method of claim 6 wherein the corresponding location in the input image in step (d) is computed by modeling its x-coordinate with one mathematical function and its y-coordinate with another mathematical function.

8. The method of claim 7 wherein the two mathematical functions are generated using a Thin Plate Splines technique.

9. The method of claim 6 wherein the computation of correspondence for every pixel location is preceded by the generation of control points in which the correspondence is computed for a subset of pixel locations.

10. The method of claim 9 wherein the subset of pixel locations consists of one or more points lying on one or more text lines.

11. The method of claim 9 wherein the subset of pixel locations consists of the left and right endpoints of one or more text lines.

12. The method of claim 6 wherein the output pixel color or intensity is computed from the four nearest pixels in the input image.

13. A method for processing a photographed image containing text lines comprising text characters having tip points and vertical strokes comprising:
(a) detecting text regions by finding a set of pixels in the photographed image that correspond to the text characters and creating a binary image containing only said set of pixels, the set of pixels are grouped into character regions, the characters regions are grouped into text lines;
(b) detecting shape by identifying the tip points and vertical strokes of the text characters;
(c) detecting orientation of the text; and
(d) transforming based on a grid building process where the identified tip points and vertical strokes are used as a basis to identify the warping of the document.

14. The method of claim 13 wherein the detecting shape step fits splines to the top and bottom of text lines to approximate the original document shape.

15. The method of claim 13 wherein the detecting text regions step further comprising the following steps:
(a1) estimating the foreground text by a standard or naïve thresholding method;
(a2) removing these foreground pixels from the original image;
(a3) filling the holes left by the removal by interpolating from the remaining values that provides a new estimate for the background by removing the initial thresholding and interpolating over the holes;
(a4) thresholding based on the improved estimate of the background.

16. The method of claim 13 wherein the transform step relies on a grid building process where the extracted features are used as a basis to identify the warping of the document.

17. The method of claim 13 wherein the transform step relies on an optimization-problem.

18. A computer system for processing a photographed image containing text lines comprising text characters having vertical strokes, the computer system carrying one or more sequences of one or more instructions which, when executed by one or more processors, cause the one or more processors to perform the computer-implemented steps of:
(a) binarization using pixel normalized thresholding to identify pixels in the image that make up the text;
(b) detecting typographical features indicative of the orientation of text;
(c) fitting one or more curves to a text line;
(d) building a grid of quadrilaterals using vectors that are parallel to the direction of the text lines and vectors parallel to the direction of the vertical stroke lines;
(e) dewarping the document by stretching the image so that vectors parallel to the text lines and vectors parallel to the direction of the vertical stroke lines become orthogonal; and
(f) processing the dewarped document with an optical character recognition software.

19. A computer system for processing a photographed image containing text lines comprising text characters having vertical strokes, the computer system carrying one or more sequences of one or more instructions which, when executed by one or more processors, cause the one or more processors to perform the computer-implemented steps of:
(a) detecting the top and bottom tip points of the text lines;
(b) fitting one curve to the top tip points and one curve to the bottom tip points for each of the text lines;
(c) determining the page orientation of the photographed image by distinguishing the top and bottom portions of text lines;
(d) computing approximate orientation for each text line and removing outliners among text lines;
(e) finding vertical paragraph boundaries by determining whether the start points or end points of text lines are lined up;
(f) detecting vertical strokes in text characters by scanning in local vertical direction to obtain vertical blocks of pixels at each of the intersection point of a centroid spline of a text line with the text pixels of text characters;
(g) building a grid of quadrilaterals using vectors that are parallel to the direction of the text lines and vectors parallel to the direction of the vertical stroke lines; and
(h) dewarping the document by stretching the image so that vectors parallel to the text lines and vectors parallel to the direction of the vertical stroke lines become orthogonal.

20. A computer system for processing a photographed image containing text lines comprising text characters having vertical strokes, the computer system carrying one or more sequences of one or more instructions which, when executed by one or more processors, cause the one or more processors to perform the computer-implemented steps of:
(a) detecting text regions by finding a set of pixels in the photographed image that correspond to the text characters and creating a binary image containing only said set of pixels, the set of pixels are grouped into character regions, the characters regions are grouped into text lines;
(b) detecting shape by identifying the tip points and vertical strokes of the text characters;
(c) detecting orientation of the text; and
(d) transforming based on a grid building process where the identified tip points and vertical strokes are used as a basis to identify the warping of the document.
